(19) United States
(12) Patent Application Publication
(10) Pub. No.: US 2014/0181474 A1
(43) Pub. Date: Jun. 26, 2014

(54) ATOMIC WRITE AND READ MICROPROCESSOR INSTRUCTIONS

(71) Applicant: TELEFONAKTIEBOLAGET L M ERICSSON (PUB, Stockholm (SE)

(72) Inventors: EVAN GEWIRTZ, PLEASANTON, CA (US); ROBERT HATHAWAY, SUNNYVALE, CA (US); EDWARD HO, FREMONT, CA (US); STEPHAN MEIER, LOS ALTOS, CA (US)

(73) Assignee: TELEFONAKTIEBOLAGET L M ERICSSON (PUBL), STOCKHOLM (SE)

(21) Appl. No.: 13/727,282

(22) Filed: Dec. 26, 2012

(51) Int. Cl. G06F 9/52

(52) U.S. Cl. CPC G06F 9/52
USPC 712/206

(57) ABSTRACT

Methods and apparatus for performing an atomic hardware operation (HWOP) instruction. According to a method in a computer processor coupled to a memory, the method includes fetching, decoding, and executing the atomic HWOP instruction. The instruction includes a source operand indicating a source location and a destination operand indicating a destination location, wherein each of the source location and the destination location is either a register of the computer processor or an address of the memory. Executing the atomic HWOP instruction includes sending a message to an external agent to cause the external agent to atomically access a set of one or more memory locations of the memory based upon a value stored at the source location, and return a result obtained from said atomic access of the set of memory locations to the destination location. The external agent is external to the computer processor.

### FIELD

Embodiments of the invention relate to the field of computer processor architecture; and more specifically, to instructions that when executed cause a particular result.

### BACKGROUND

It is common in multiprocessing and multithreaded computing environments for various executable units running on a computer system to concurrently execute multiple jobs scheduled in a queue, which is accessed by multiple threads and/or multiple executable units.

A common problem associated with using data structures in shared memory is managing multiple simultaneous requests to access the data structures and ensuring that accesses to the data are atomic. Additionally, guaranteeing atomic access is important because it ensures that multiple simultaneous attempts to update data do not conflict and leave the data in an inconsistent state.

One typical atomic operation referred to by the phrase “read-modify-write” involves first reading a memory location and then writing a new value into that location in a quasi-simultaneous manner, either with a completely new value or some function of the previous value. Read-modify-write operations are typically used to prevent race conditions in multi-threaded applications.

However, in highly multi-threaded and multi-core microprocessor systems, it can be difficult for the processing elements to send complex commands to hardware accelerators and intelligent (e.g., transactional) memory and receive responses to those commands in an atomic fashion. This can require solutions in the target blocks which are difficult to scale as the number of processing elements increases.

Multi-processor systems currently use several techniques to achieve atomic read-modify write behavior. The primary examples of such techniques involve the use of fixed atomic instructions such as compare and swap, or atomic primitives such as load-link/store-conditional.

While atomic operations for read-modify-write behavior are useful for some operations, they are generally targeted at a single memory location at which the operation is performed, which does not allow for complex operations that access multiple memory locations. Also, these atomic operations are limited in terms of the number of logical operations that can be supported since that definition is usually encoded in the instruction itself, where opcode encodings are generally a limited resource.

“Load-link/store-conditional” operations refer to a pair of instructions (load-link and store-conditional) allowing synchronization by first returning a value of a memory location (the load-link) and then storing a new value to that memory location only if no updates have occurred to that location (the store-conditional). Such operations can allow for more complex operations to multiple memory locations, but this approach does not scale well with very large numbers of threads accessing these locations simultaneously. Since these operations inherently consist of multiple transactions, they are inherently non-atomic, so it can be difficult to enforce flow control and avoid deadlock with straightforward implementations. Furthermore, when a load-link/store-conditional operation encounters a conflict with another requesting agent, the memory agent typically indicates that the store-conditional operation failed by sending a negative reply to the original agent, which must attempt to perform the operation again. This can be inefficient from a power and performance standpoint.

### SUMMARY

According to an embodiment of the invention, a method of performing an atomic hardware operation (HWOP) instruction in a computer processor coupled to a memory is described. The method includes fetching the atomic HWOP instruction, which includes a source operand indicating a source location and a destination operand indicating a destination location. Each of the source location and the destination location is either a register of the computer processor or an address of the memory. The method further includes decoding the fetched atomic HWOP instruction, and executing the decoded atomic HWOP instruction by sending a message to an external agent. The external agent is located external to the computer processor. This message causes the external agent to atomically access a set of one or more memory locations of the memory based upon a value stored at the source location. This message also causes the external agent to return a result obtained from said atomic access of the set of memory locations to the destination location.

In another embodiment of the invention, an apparatus is described that includes a hardware decode unit and an execution unit. The hardware decode unit is configured to decode an atomic hardware operation (HWOP) instruction, which includes a source operand indicating a source location and a destination operand indicating a destination location. Each of the source location and the destination location is either a register or an address of a memory. The execution unit is configured to execute the decoded atomic HWOP instruction. The execution of the decoded atomic HWOP instruction includes sending a message to an external agent, which causes the external agent to atomically access a set of one or more memory locations of the memory based upon a value stored at the source location, and return a result obtained from said atomic access of the set of memory locations to the destination location.

In another embodiment of the invention, a non-transitory machine-readable storage medium is described. The non-transitory machine-readable storage medium includes a computer program operable to translate non-native program instructions to form native program instructions decodable by an apparatus for processing data having processing logic operable to perform data processing operations and an instruction decoder operable to decode an atomic hardware operation (HWOP) instruction to perform data processing operations specified by the native program instructions. The atomic HWOP instruction includes a source operand indicating a source location, which is either a register or an address of a memory, and also includes a destination operand indicating a destination location, which is also either a register or an address of the memory. The native program instructions include sending a message to an external agent, which causes the external agent to atomically access a set of one or more memory locations of the memory based upon a value stored at the source location, and return a result obtained from said atomic access of the set of memory locations to the destination location.

Embodiments of the invention allow for atomic operations to be performed without a need for extra resources or logic required to link a read and write (as occurs in load-link/store conditional types of operations), which assists with resource management, flow control, and deadlock avoidance. Additionally, the atomic HWOP instruction is a more flexible construct than fixed atomic operators such as compare-and-swap, as it, in some embodiments, uses data contained in either memory or registers as the command to be executed at the external agent, which allows for a much wider range of commands to be executed and is much more efficient in terms of instruction opcode space. It also allows the commands to be dynamically created during run-time. Further, HWOP instruction can allow process spawning without the use of interrupts and the overhead associated with them.

### BRIEF DESCRIPTION OF THE DRAWINGS

The invention may best be understood by referring to the following description and accompanying drawings that are used to illustrate embodiments of the invention. In the drawings:

FIG. 1 illustrates a detailed diagram of a processor, according to one embodiment of the invention;

FIG. 2 illustrates a block diagram of a computing system enabling atomic write and read instructions according to one embodiment of the invention;

FIG. 3 illustrates sending messages to an external agent to cause the external agent to perform atomic memory operations according to one embodiment of the invention;

FIG. 4 illustrates a Hardware Operation instruction format and block formats used to pass data to and from external agents according to one embodiment of the invention; and

FIG. 5 illustrates a flow for performing an atomic hardware operation instruction in a computer processor coupled to a memory according to one embodiment of the invention.

### DESCRIPTION OF EMBODIMENTS

The following description describes methods, systems, apparatus, and instructions for atomic write and read microprocessor instructions. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been illustrated in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Exemplary Processor

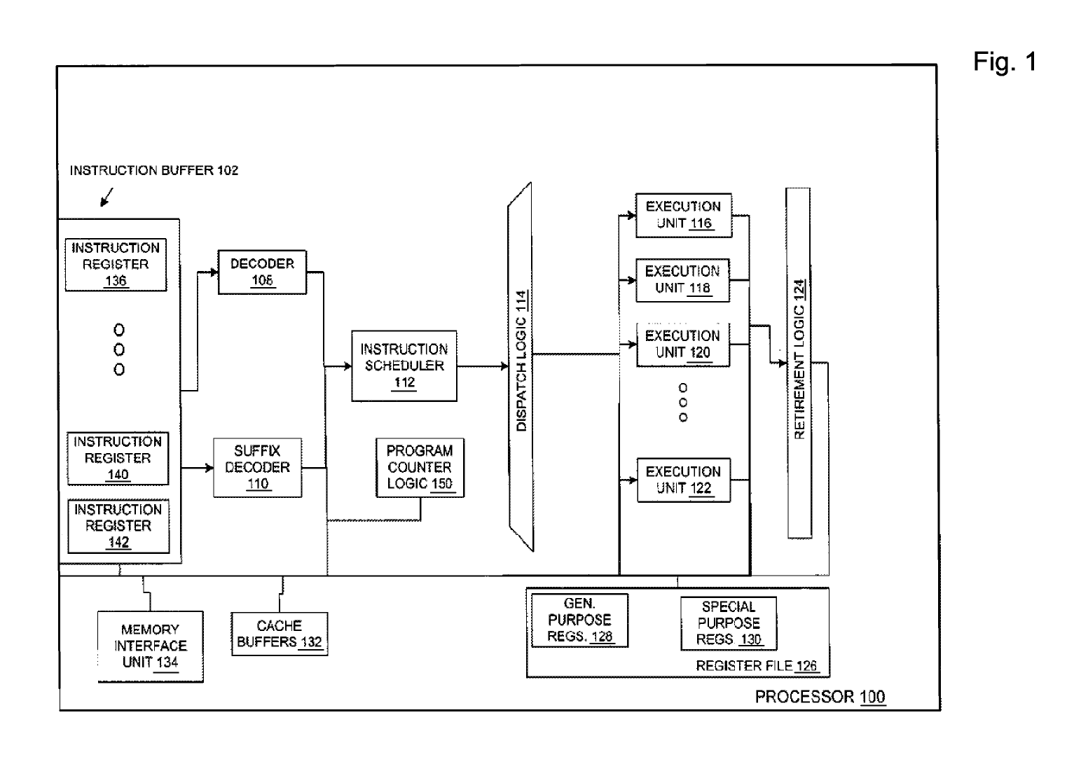

FIG. 1 illustrates a detailed diagram of a processor, according to one embodiment of the invention. As shown, processor 100 of FIG. 1 comprises memory interface unit 134 coupled to cache buffers 132, register file 126 and instruction buffer 102. Register file 126 comprises general-purpose registers 128 and special purpose registers 130. In one embodiment, general-purpose registers 128 can include one to a number of registers. In an embodiment, special purpose registers 130 can include one to a number of registers. In an embodiment, one of the special purpose registers 130 includes a program counter register, which is described in more detail below. Instruction buffer 102 comprises instruction registers 136-142. In one embodiment, instruction buffer 102 can include one to a number of such registers for storing instructions for execution within processor 100.

As will be described in more detail below, memory interface unit 134 can retrieve macro instructions and associated operands and store such data into instruction buffer 102 and cache buffers 132, general purpose registers 128 and/or special purpose registers 130. Additionally, cache buffers 132, memory interface unit 134 and register file 126 are coupled to decoder 108, suffix decoder 110, program counter logic 150, execution units 116-122 and retirement logic 124. In an embodiment, program counter logic 150 updates a program counter stored in one of special purpose registers 130, which is described in more detail below.

Decoder 108 and suffix decoder 110 are coupled to instruction buffer 102, such that decoder 108 and suffix decoder 110 retrieve the instructions from instruction registers 136-142 within instruction buffer 102. Decoder 108 can receive and decode these instructions to determine the given instruction and also to generate a number of instructions in an internal instruction set. For example, in one embodiment, the instructions received by decoder 108 are termed macro instructions, while the instructions that are generated by decoder 108 are termed micro instructions (or micro-operations).

As will be described in more detail below, suffix decoder 110 can receive and decode these instructions to determine if a given instruction is a suffix to a prior instruction. In one embodiment, this suffix instruction includes a destination register for the results of the execution of the prior instruction. Decoder 108 and suffix decoder 110 are also coupled to instruction scheduler 112, such that instruction scheduler 112 can receive these micro-operations for scheduled execution by execution units 116-122.

Instruction scheduler 112 is coupled to dispatch logic 114, such that the instruction scheduler 112 transmits the instructions to be executed by execution units 116-122. Dispatch logic 114 is coupled to execution units 116-122 such that dispatch logic 114 transmits the instructions to execution units 116-122 for execution. Execution units 116-122 can be one of a number of different execution units, including, but not limited to, an integer arithmetic logic unit (ALU), a floating-point unit, memory load/store unit, etc. Execution units 116-122 are also coupled to retirement logic 124, such that execution units 116-122 execute the instructions and transmit the results to retirement logic 124. Retirement logic 124 can transmit these results to memory that can be internal or external to processor 100, such as registers within register file 126 or cache buffers 132, or memory external to processor 100 (not shown).

Electronic Devices and Network Elements

An electronic device (e.g., an end station, a network element) stores and transmits (internally and/or with other electronic devices over a network) code (composed of software instructions) and data using computer-readable media, such as non-transitory tangible computer-readable media (e.g., computer-readable storage media such as magnetic disks; optical disks;read only memory; flash memory devices) and transitory computer-readable transmission media (e.g., electrical, optical, acoustical or other form of propagated signals—such as carrier waves, infrared signals). In addition, such electronic devices typically include a set of one or more processors coupled to one or more other components, such as one or more non-transitory machine-readable media (to store code and/or data), user input/output devices (e.g., a keyboard, a touchscreen, and/or a display), and network connections (to transmit code and/or data using propagating signals). The coupling of the set of processors and other components is typically through one or more busses and bridges (also termed as bus controllers). Thus, a non-transitory computer-readable medium of a given electronic device typically stores instructions for execution on one or more processors of that electronic device. One or more parts of an embodiment of the invention may be implemented using different combinations of software, firmware, and/or hardware.

As used herein, a network element (e.g., a router, switch, bridge) is a piece of networking equipment, including hardware and software, which communicatively interconnects other equipment on the network (e.g., other network elements, end stations). Some network elements are “multiple services network elements” that provide support for multiple networking functions (e.g., routing, bridging, switching, Layer 2 aggregation, session border control, Quality of Service, and/or subscriber management), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VOIP) phones, user equipment, terminals, portable media players, GPS units, gaming systems, set-top boxes) access content/services provided over the Internet and/or content/services provided on virtual private networks (VPNs) overlaid on (e.g., tunneled through) the Internet. The content and/or services are typically provided by one or more end stations (e.g., server end stations) belonging to a service or content provider or end stations participating in a peer to peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network elements, which are coupled (e.g., through one or more core network elements) to other edge network elements, which are coupled to other end stations (e.g., server end stations).

Network elements are commonly separated into a control plane and a data plane (sometimes referred to as a forwarding plane or a media plane). In the case that the network element is a router (or is implementing routing functionality), the control plane typically determines how data (e.g., packets) is to be routed (e.g., the next hop for the data and the outgoing port for that data), and the data plane is in charge of forwarding that data. For example, the control plane typically includes one or more routing protocols (e.g., Border Gateway Protocol (BGP), Interior Gateway Protocol(s) (IGP) (e.g., Open Shortest Path First (OSPF), Routing Information Protocol (RIP), Intermediate System to Intermediate System (IS-IS)), Label Distribution Protocol (LDP), Resource Reservation Protocol (RSVP)) that communicate with other network elements to exchange routes and select those routes based on one or more routing metrics.

Typically, a network element includes a set of one or more line cards, a set of one or more control cards, and optionally a set of one or more service cards (sometimes referred to as resource cards). These cards are coupled together through one or more mechanisms (e.g., a first full mesh coupling the line cards and a second full mesh coupling all of the cards). The set of line cards make up the data plane, while the set of control cards provide the control plane and exchange packets with external network element through the line cards. The set of service cards can provide specialized processing (e.g., Layer 4 to Layer 7 services (e.g., firewall, IPsec, IDS, P2P), VoIP Session Border Controller, Mobile Wireless Gateways (GGSN, Evolved Packet System (EPS) Gateway)). By way of example, a service card may be used to terminate IPsec tunnels and execute the attendant authentication and encryption algorithms.

Instruction Sets

An instruction set, or instruction set architecture (ISA), is the part of the computer architecture related to programming, and may include native data types, instructions, register architecture, addressing modes, memory architecture, interrupt and exception handling, and external input and output (I/O). In some circumstances, the term instruction refers to macro-instructions, which are instructions provided to the processor (or instruction converter that translates (e.g., using static binary translation, dynamic binary translation including dynamic compilation), morphs, emulates, or otherwise converts an instruction to one or more other instructions to be processed by the processor) for execution—as opposed to micro-instructions or micro-operations (micro-ops)—that is the result of a processor's decoder decoding macro-instructions.

The ISA is distinguished from the microarchitecture, which is the internal design of the processor implementing the instruction set. Processors with different microarchitectures can share a common instruction set. For example, the same register architecture of the ISA may be implemented in different ways in different microarchitectures using well-known techniques, including dedicated physical registers, one or more dynamically allocated physical registers using a register renaming mechanism (e.g., the use of a Register Alias Table (RAT), a Reorder Buffer (ROB), and a retirement register file; the use of multiple maps and a pool of registers), etc. Unless otherwise specified, the phrases register architecture, register file, and register are used herein to refer to that which is visible to the software/programmer and the manner in which instructions specify registers. Where a specificity is desired, the adjective logical, architectural, or software visible will be used to indicate registers/files in the register architecture, while different adjectives will be used to designation registers in a given microarchitecture (e.g., physical register, reorder buffer, retirement register, register pool).

An instruction set includes one or more instruction formats. A given instruction format defines various fields (number of bits/bytes, location of bits/bytes) to specify, among other things, the operation to be performed (opcode) and the operand(s) on which that operation is to be performed. Some instruction formats are further broken down through the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

It should be understood that the term destination vector operand (or destination operand) is defined as the direct result of performing the operation specified by an instruction, including the storage of that destination operand at a location (be it a register or at a memory address specified by that instruction) so that it may be accessed as a source operand by another instruction (by specification of that same location by the another instruction).

Embodiments of the instruction(s) described herein may be embodied in different formats. Additionally, while exemplary systems and architectures are detailed herein, embodiments of the instruction(s) may be executed on such systems, architectures, and pipelines, but are not limited to those detailed.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

Atomic Write and Read Microprocessor Instructions

Systems, apparatuses, methods and instructions for atomic write and read operations are described. In one embodiment of the invention, an instruction deemed a “Hardware Operation” (or “HWOP”) instruction allows the CPU to send an arbitrarily sized command or set of commands from a memory or register location to an external agent, where this command is atomically executed. In an embodiment of the invention, the external agent is either a hardware accelerator or a transactional memory. The external agent may guarantee the atomicity of execution in several ways, such as by processing memory requests serially, comparing addresses in memory requests and only serializing accesses when there is an address conflict while executing orthogonal operations in parallel.

In an embodiment of the invention, the HWOP instruction also includes a request for an arbitrarily sized data return from the external agent to the CPU. By combining the write and read semantics into a single instruction, the context storage required by the target block can be scaled based solely on the throughput requirements of that block, and not on the number of threads sending requests. Additionally, flow control can be accomplished through generic on-chip interconnect mechanisms, or by a simple credit interface scheme without having to retry operations. In an embodiment, a forwarding extension allows the response generated by the request to be sent to a third location as specified in the original command.

By combining the write are read aspects of an operation into one HWOP instruction, several advantages are realized. Since a single operation is sent across the on-chip network atomically, no extra resources or logic is required to link the read and write (as occurs in load-link/store conditional types of operations). This assist with resource management, flow control, and deadlock avoidance.

Additionally, the HWOP is a more flexible construct than fixed atomic operators such as compare-and-swap in that it uses data contained in either memory or registers (for example) as the command to be executed at the external agent, which allows for a much wider range of commands to be executed and is much more efficient in terms of instruction opcode space. It also allows the commands to be dynamically created during run-time. Since there is a rather large limit on the size of the data payload, there is a much higher bound to the complexity of operations that can be performed. This could also include sending a command to another microprocessor with a pointer to a program of any size to be run on behalf of the original agent. This could allow for process spawning without the use of interrupts and the overhead associated with them.

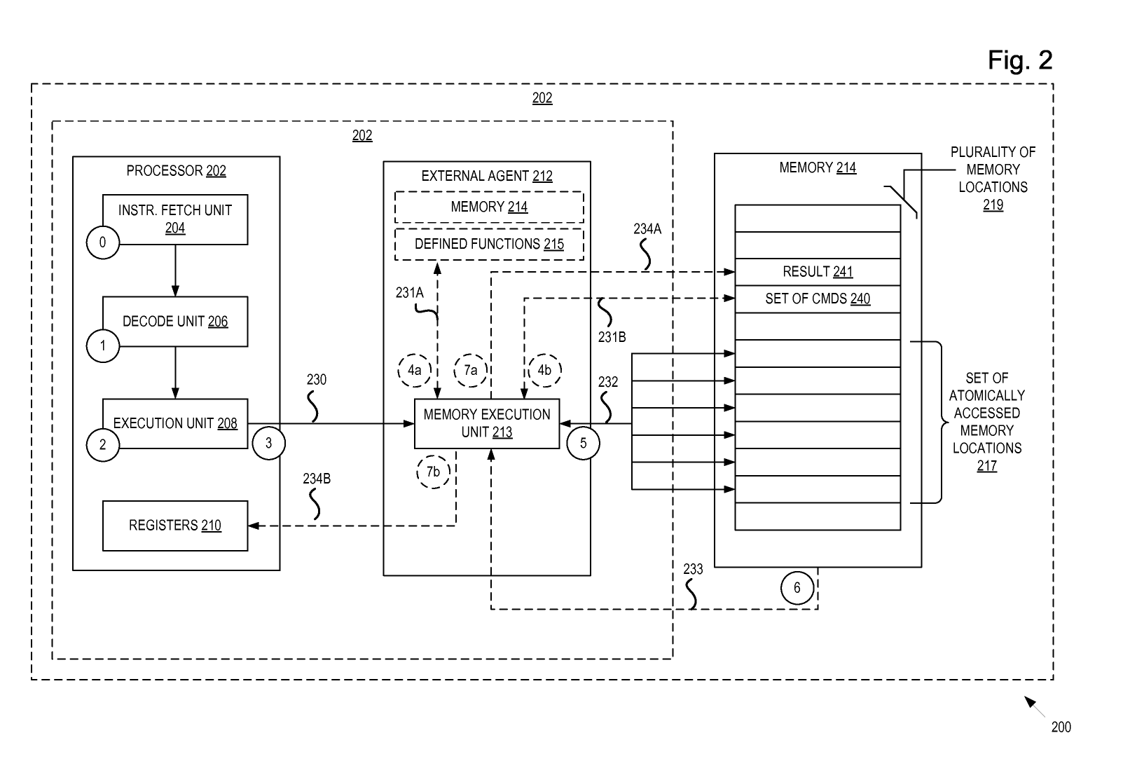

FIG. 2 illustrates a block diagram of a computing system 200 enabling atomic write and read instructions according to one embodiment of the invention. In an embodiment, the processor 202 is configured to utilize a HWOP instruction implemented as an instruction in an ISA that defines the behavior of a microprocessor. In an embodiment, the HWOP instruction combines an arbitrarily-sized write request with an arbitrarily-sized read request into a single instruction to be performed by an external agent 212. In some embodiments, the write data will be treated as a command or a set of one or more commands that an external agent 212 is requested to execute. In some embodiments, the requested operation is fixed, and the write data will be used as the input data (i.e., argument(s)) to that fixed function. In an embodiment, the set of commands may be as simple as a complex read-modify-write operation, or as complex as a micro-coded instruction stream that performs many memory accesses as well as computational and logical operations. In an embodiment, the write data includes a pointer to a memory location that contains further command information (e.g., additional commands to execute).

In an embodiment of the invention, a processor 202 of a computing system 200 includes an instruction fetch unit 204, a decode unit 206, an execution unit 208, and a set of one or more registers 210. In embodiments, the processor 202 also includes an external agent 212, and in some embodiments the processor 202 also includes both the external agent 212 and the memory 214.

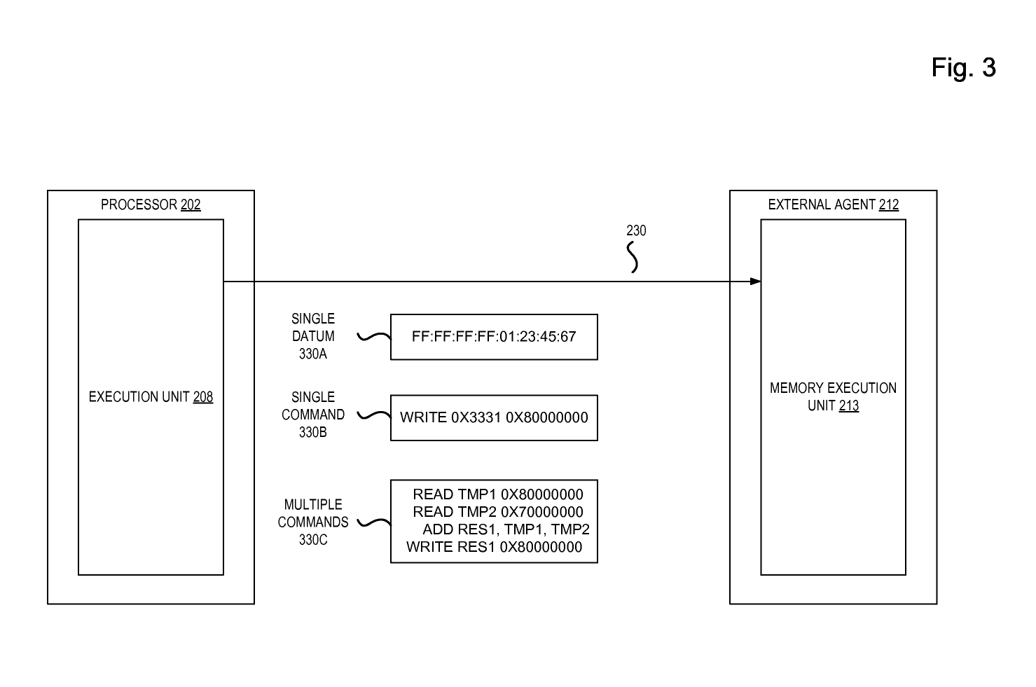

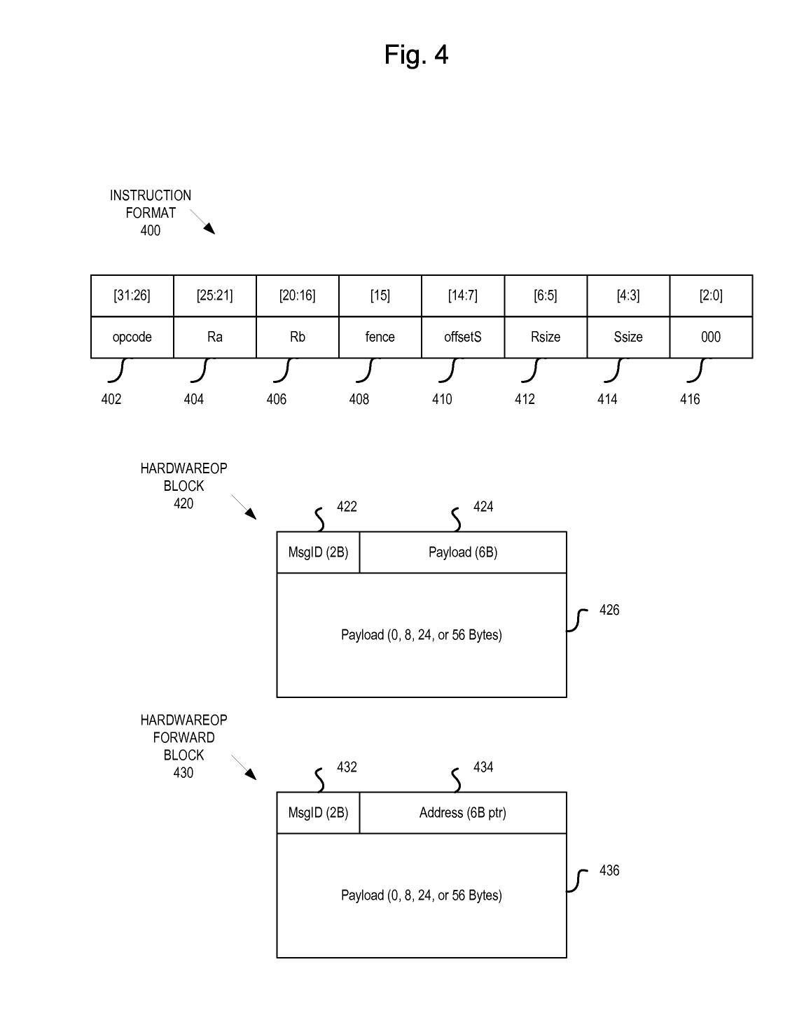

At circle ‘0’, the instruction fetch unit 204 fetches a HWOP instruction, and at circle ‘1’ the HWOP instruction is decoded by a decode unit 206. In embodiments of the invention, the HWOP instruction includes a source operand 404 indicating a source location and a destination operand 404 indicating a destination location. In some embodiments, the HWOP instruction includes other fields, some of which are illustrated later herein by FIG. 4. At a next stage, the execution unit 208 begins to execute the HWOP instruction at circle ‘2’. In an embodiment, executing the HWOP instruction includes sending a message 230 to an external agent 212, as depicted at circle ‘3’. Exemplary formats and details regarding exemplary contents of this message 230 are presented later herein with regard to FIG. 3 and FIG. 4.

In an embodiment, when the processor 202 executes the HWOP instruction, it is first treated as a generic write of an arbitrary size as specified in the instruction. Depending upon the embodiment, the source of the write data (e.g. the source location identified by the source operand) may be the processor's general purpose register file 210 or a memory 214 location. In an embodiment where the source of the write data is a memory location, the HWOP is treated as three memory operations, with the first being a read of the location containing the write data. Once the write has been sent to the external agent 212 (e.g., memory system, hardware accelerator, search engine, policing/rate limiting hardware block, Ternary Content-addressable Memory (TCAM) interface block, etc.), the instruction is further treated as an arbitrarily-size read request, and all necessary dependency checking on subsequent instructions is performed.

After receipt of the message 230, a memory execution unit 213 of the external agent 212 performs one or more operations using the memory 214, which may be within the external agent 212 or outside the external agent 212 (depending upon the embodiment).

At circle ‘4a’, in an embodiment of the invention, the memory execution unit 213 is configured to use 231A one or more defined functions (from a defined functions 215 storage location, or defined functions implemented in hardware itself) to service the HWOP instruction. In some embodiments, a value in the message 230 sent to the memory execution unit 213 indicates which of a plurality of functions are to be used, but in some embodiments the memory execution unit 213 executes only one function. In an embodiment, the function utilizes one or more units of data indicated by the source operand as inputs to the function. For example, in an embodiment a function performs an atomic “lookup” in a set of memory locations (e.g., 217) using a search key (e.g., a 32-bit Internet Protocol Version 4 (IPv4) address, a 16 Byte/128-bit Internet Protocol Version 6 (IPv6) address, etc.) as an input to determine if there is a match. However, in another embodiment the function does not use any input values and performs a fixed routine of operations. For example, the function may perform an atomic sort operation on the values in a set of memory locations (e.g. 217). In addition, the function may utilize a plurality of inputs, such as a search key and an indication (or indications) of the memory addresses to be searched within. In certain embodiments, the function may be any number of logical operations, including but not limited to performing a computational operation such as a cryptography function on a portion of data or calculating a hash on a portion of data.

In an embodiment of the invention, as illustrated at circle ‘4b’, the memory execution unit 213 is configured to retrieve 231 B and execute a set of commands 240 from memory 214. The location of this set of commands 240, in an embodiment, is indicated by the value of the source operand of the HWOP instruction, and may be transmitted within the message 230. This set of commands 240 could include one command or multiple commands that are to be performed atomically. As a simple example, the set of commands could include a “read data” at a first memory location, “read data” at a second memory location, perform an arithmetic or logical operation on the two pieces of data (e.g., add, multiply, XOR, OR, AND, NOT, etc.), and store the result in a third memory location (or either the first or second memory locations) or return the value to the requesting processor (e.g. 202) in a message. Of course, the commands may be implemented using any number of bit representations, provided the memory execution unit 213 is configured to be able to “understand” the instructions. The selection of such representations is well known to those of skill in the art, and is not further described herein.

In another embodiment, the set of commands to be atomically executed by the external agent 212 is included within the message 230 itself.

At circle ‘5’, the memory execution unit 213 atomically executes the set of commands by accessing 232 (e.g., reading from, writing to) a set of atomically accessed memory locations 217. In some embodiments, the external agent 212 is able to ensure atomicity by it being the sole owner of that portion of memory being accessed (e.g. the set of atomically accessed memory locations 217). In an embodiment, the external agent 212 is the sole point of access to the memory 214, and thus can guarantee atomic accesses to the memory 214 by a careful scheduling (i.e., ordering) of accesses. For example, the external agent 212 could execute a number of read-only atomic operations (e.g., each representing a search for a particular value) in parallel, and then upon receipt of a write request to a memory location in that set 217, stall the write request, allow the read-only atomic operations to continue until completion (while preventing new read-only atomic operations from beginning, or at least prevent some new read-only atomic operations), and then execute the write request.

At circle ‘6’, the memory execution unit 213 optionally receives a result 233 from atomically performing the set of commands in the memory 214. In some embodiments, though, the result is already known within the memory execution unit 213 by having performing the set of commands therein.

With the result from the completion of the atomic execution of the set of commands, the memory execution unit 213 at circle ‘7a’ may optionally be configured to write 234A the result 241 to a location of the plurality of memory locations 219 in memory 214. In an embodiment, this location is the location identified by the destination operand of the HWOP instruction. In an embodiment, the location is included within the message 230 sent to the external agent 212 by the processor 202. With the result 241 written to memory, a process/thread that originally caused execution of the HWOP may read the result 241 from memory, one or more other processes/threads may read the result 241, or both.

In an embodiment, the memory execution unit 213 at circle ‘7b’ is configured to have the result written 234B to a register 210 of the processor 202. In an embodiment, this register 210 location is the location identified by the destination operand of the HWOP instruction. In an embodiment, the register 210 location is included within the message 230 sent to the external agent 212 by the processor 202. In an embodiment, the memory execution unit 213 is configured to always write a result to a particular register 210 of the processor 202 (or to a particular memory location).

FIG. 3 illustrates sending messages 230 to an external agent 212 to cause the external agent 212 to perform atomic memory operations according to one embodiment of the invention. As described above with respect to FIG. 2, the message 230 generated by the execution unit 208 and sent to the memory execution unit 213 may be in a number of different formats. As depicted by 330A, the message 230 may include a single datum 330A. This single datum 330A, in an embodiment, is a value from a location indicated by the source operand of the HWOP instruction. In various embodiments, the value is from one of a register 210, a location of memory 214, or directly from within the HWOP instruction. In the depicted example, the single datum 330A is a 16 Byte IPv6 address, but in other embodiments it can be another value of a different size. In an embodiment, the single datum 330A may be used by the memory execution unit 213 with a defined function 215 to atomically perform memory operations. In an embodiment, the single datum 330A is a memory address indicating a location in the memory 214 where a set of commands 240 to be executed atomically are located.

According to an embodiment, the message 430 may include a single command 330B. In the depicted example, the single command is a “write command” indicating that a particular source operand value (within the command or at a location identified by the write command) is to be written to a particular destination operand location in the memory 214. In an embodiment, the message 230 includes multiple commands 330C to be executed atomically by the memory execution unit 213. In the depicted embodiment, the multiple commands 330C instruct the memory execution unit 213 to read a first value from the memory, read a second value from the memory, add the first value and second memory together and store the result as a temporary value, and write the temporary value to a location of the memory (e.g., 241) as the result.

FIG. 4 illustrates a Hardware Operation instruction format 400 and block formats (420, 430) used to pass data to and from external agents according to one embodiment of the invention. In an embodiment, the HWOP instruction format 400 includes eight fields; however, in other embodiments of the invention there are more fields, and in other embodiments there are fewer fields.

In the depicted embodiment, bits 26 to 31 represent an opcode 402 for the HWOP instruction. In an embodiment, there is an opcode for a HWOP instruction that returns a result of the atomic memory operations to the processor, and in an embodiment, there is an opcode for a Hardware Operation Forwarding (HWOPF) version of the instruction that includes a forwarding address where the external agent 212 is to send or write the result to. For example, the HWOPF may support a scenario where it is desirable to send the return data not to the originating thread but instead to another destination, such as when software pipelining is employed. Thus, the HWOPF instruction is an atomic operation that allows the destination of the read portion of the command to be programmable, and independent of the source agent. This can be a large advantage in implementations that include software pipelining or pipelining between hardware and software operations.

Bits 25 to 21 represent a source ‘Ra’ 404 that indicates a register containing a source memory address containing the set of commands 240 to be executed. Bits 20 to 16 represent a destination ‘Rb’ 406 that indicates a register containing a destination memory address at which the result should be written. Bit 15 represents a “fence” 408 bit that indicates, to the processor 202, that a memory barrier (i.e., a memory fence) should be created to enforce an ordering constraint on memory operations issued before and after this instruction.

Bits 14 to 7 represent an offset 410 (“offsetS”) that can be transformed (e.g. bit-shifted) and added to the contents of the destination memory address (from Rb 406) to form a different destination memory address. Bits 6 and 5 represent a size 412 (e.g., in bytes) of the source data (i.e., the set of commands 240). In an embodiment, a bit value ‘00’ indicates that the source data is 8 bytes in size, a bit value of ‘01’ indicates 16 bytes, a bit value of ‘10’ indicates 32 bytes, and a bit value of ‘11’ represents that the size of the source data is 64 bytes. Similarly, bits 4 and 3 indicate a destination size 414 for the result data. In an embodiment, a bit value ‘00’ indicates that the result data is 8 bytes in size, a bit value of ‘01’ indicates 16 bytes, a bit value of ‘10’ indicates 32 bytes, and a bit value of ‘11’ represents that the size of the result data is 64 bytes. Finally, bits 2 to 0 are unused 416 bits in the instruction.

FIG. 4 also illustrates block formats (420, 430) used to pass data to and from external agents according to one embodiment of the invention. These block formats, in an embodiment of the invention, are the format of the message 430 sent to the external agent 212 causing the atomic operations to be executed.

The first Hardware Operation block (HWOPB) 420 is one block format used in an embodiment. The HWOPB 420 includes a ‘MsgID’ field 422 that is two bytes, which is interpreted by the external agent 212 and provides a command to the external agent 212 which will enable it to know how to interpret the remainder of the HWOPB. In various embodiment, a first payload 424 of six bytes and a second (variable sized) payload 426 of 0, 8, 24, or 56 bytes may be used separately as two distinct values or may be used together to form one large value to be used by the external agent 212. In some embodiments these payloads (424, 426) include data values to be used as an argument with an atomic function, and in other embodiments these payloads include a set of commands to be executed atomically.

The second Hardware Operation Forward Block (HWOPFB) 430 is a second block format used in an embodiment. The HWOPFB 430, similar to the HWOPB 420 described above, also includes a ‘MsgID’ 432 field and a variable sized payload 436. However, the HWOPFB 430 includes an ‘Address’ 434 field that is a 6 byte pointer to a memory address where the result of the atomic operations should be placed. In an embodiment, the memory address is a logical address that needs to be translated to an absolute address. In an embodiment, this translation occurs by the external agent 212, but in other embodiments this translation occurs within the execution unit 208.

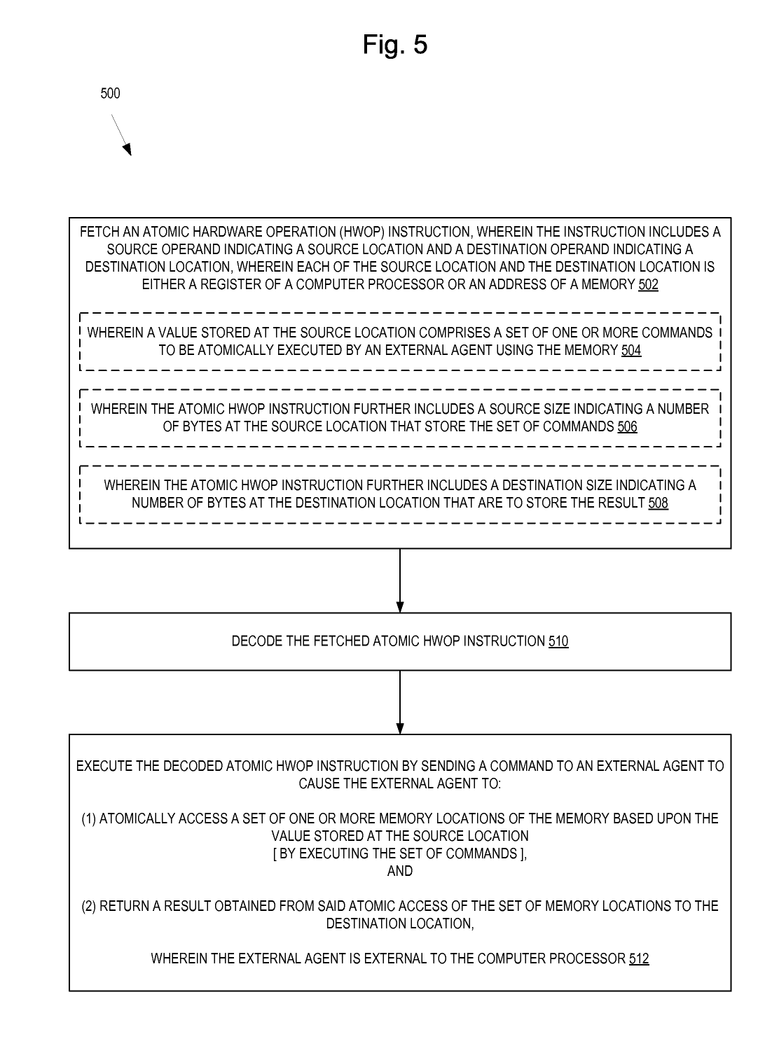

FIG. 5 illustrates a flow 500 for performing an atomic hardware operation instruction in a computer processor 202 coupled to a memory 214 according to one embodiment of the invention. The operations of this flow diagram will be described with reference to the exemplary embodiments of the other diagrams. However, it should be understood that the operations of the flow diagram of FIG. 5 can be performed by embodiments of the invention other than those discussed with reference to these other diagrams, and the embodiments of the invention discussed with reference to these other diagrams can perform operations different than those discussed with reference to the flow diagram. Additionally, while this flow diagram illustrates a particular order of operations performed by certain embodiments of the invention, it should be understood that such order is only exemplary (e.g., alternative embodiments may perform the operations in a different order, combine certain operations, overlap certain operations, etc.).

At step 502, the processor 202 fetches an atomic hardware operation (HWOP) instruction. The instruction includes a source operand indicating a source location and a destination operand indicating a destination location. Each of the source location and the destination location is either a register of the computer processor or an address of the memory.

Optionally, a value stored at the source location includes a set of one or more commands to be atomically executed by an external agent using the memory 504. Also, the atomic HWOP instruction optionally further includes a source size indicating a number of bytes at the source location that store the commands 506. The atomic HWOP instruction optionally further includes a destination size indicating a number of bytes at the destination location that are to store the result 508.

At step 510, the processor 202 decodes the atomic HWOP instruction. Then, the processor 202 executes 512 the decoded atomic HWOP instruction by sending a command to an external agent, which is external to the computer processor. This causes the external agent to first atomically access a set of one or more memory locations of the memory based upon the value stored at the source location. Optionally, this occurs by the external agent executing the set of commands. The sending of the command to the external agent also causes the external agent to return a result obtained from said atomic access of the set of memory locations to the destination location.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method of performing an atomic hardware operation (HWOP) instruction in a computer processor coupled to a memory, the method comprising:
fetching the atomic HWOP instruction, wherein the instruction includes a source operand indicating a source location and a destination operand indicating a destination location, wherein each of the source location and the destination location is either a register of the computer processor or an address of the memory;
decoding the fetched atomic HWOP instruction; and
executing the decoded atomic HWOP instruction by sending a message to an external agent to cause the external agent to:
atomically access a set of one or more memory locations of the memory based upon a value stored at the source location, and
return a result obtained from said atomic access of the set of memory locations to the destination location,
wherein the external agent is external to the computer processor.

2. The method of claim 1, wherein:
the value stored at the source location comprises a set of one or more commands to be atomically executed by the external agent using the memory; and
the external agent atomically accesses the set of memory locations by executing the set of commands.

3. The method of claim 2, wherein the atomic HWOP instruction further includes a source size, wherein the source size indicates a number of bytes at the source location that store the set of commands.

4. The method of claim 2, wherein the set of commands are dynamically created at runtime.

5. The method of claim 1, wherein the atomic HWOP instruction further includes a destination size, wherein the destination size indicates a number of bytes at the destination location that are to store the result.

6. The method of claim 1, wherein:
before the message is sent to the external agent, the atomic HWOP instruction is handled as a write instruction by the computer processor; and
after the message is sent to the external agent, the atomic HWOP instruction is handled as a read instruction by the computer processor, causing the computer processor to perform any necessary dependency checking for any subsequent instructions referencing the destination location.

7. The method of claim 1, wherein the external agent is one of a hardware accelerator and a transactional memory.

8. The method of claim 1, wherein:
the value stored at the source location is a single datum; and
the external agent atomically accesses the set of memory locations by using the single datum with a defined function.

9. An apparatus comprising:
a hardware decode unit to decode an atomic hardware operation (HWOP) instruction, wherein the atomic HWOP instruction includes a source operand indicating a source location and a destination operand indicating a destination location, wherein each of the source location and the destination location is either a register or an address of a memory; and
an execution unit to execute the decoded atomic HWOP instruction, wherein an execution of the decoded atomic HWOP instruction includes sending a message to an external agent to cause the external agent to:
atomically access a set of one or more memory locations of the memory based upon a value stored at the source location, and
return a result obtained from said atomic access of the set of memory locations to the destination location.

10. The apparatus of claim 9, wherein:
the value stored at the source location is to comprise a set of one or more commands to be atomically executed by the external agent using the memory; and
the external agent is to atomically access the set of memory locations by executing the set of commands.

11. The apparatus of claim 10, wherein the atomic HWOP instruction further includes a source size, wherein the source size is to indicate a number of bytes at the source location that store the set of commands.

12. The apparatus of claim 9, wherein the atomic HWOP instruction is to further include a destination size, wherein the destination size is to indicate a number of bytes at the destination location that are to store the result.

13. The apparatus of claim 9, wherein:
before the message is to be sent to the external agent, the atomic HWOP instruction is to be handled as a write instruction by the execution unit; and
after the message is to be sent to the external agent, the atomic HWOP instruction is to be handled as a read instruction by the execution unit, causing the execution unit to perform any necessary dependency checking for any subsequent instructions referencing the destination location.

14. The apparatus of claim 9, wherein:
the value stored at the source location is a single datum; and
the external agent is to atomically access the set of memory locations by using the single datum with a defined function.

15. A non-transitory machine-readable storage medium including a computer program operable to translate non-native program instructions to form native program instructions decodable by an apparatus for processing data having processing logic operable to perform data processing operations and an instruction decoder operable to decode an atomic hardware operation (HWOP) instruction to perform data processing operations specified by the native program instructions, wherein the atomic HWOP instruction includes a source operand indicating a source location and a destination operand indicating a destination location, wherein each of the source location and the destination location is either a register or an address of a memory, and wherein the native program instructions comprise:
sending a message to an external agent to cause the external agent to:
atomically access a set of one or more memory locations of the memory based upon a value stored at the source location, and
return a result obtained from said atomic access of the set of memory locations to the destination location.

16. The non-transitory machine-readable storage medium of claim 15, wherein:
the value stored at the source location is to comprise a set of one or more commands to be atomically executed by the external agent using the memory; and
the external agent is to atomically access the set of memory locations by executing the set of commands.

17. The non-transitory machine-readable storage medium of claim 16, wherein the atomic HWOP instruction further includes a source size, wherein the source size is to indicate a number of bytes at the source location that store the set of commands.

18. The non-transitory machine-readable storage medium of claim 15, wherein the atomic HWOP instruction is to further include a destination size, wherein the destination size is to indicate a number of bytes at the destination location that are to store the result.

19. The non-transitory machine-readable storage medium of claim 15, wherein:
before the message is to be sent to the external agent, the atomic HWOP instruction is to be handled as a write instruction by the processing logic; and
after the message is to be sent to the external agent, the atomic HWOP instruction is to be handled as a read instruction by the processing logic, causing the processing logic to perform any necessary dependency checking for any subsequent instructions referencing the destination location.

20. The non-transitory machine-readable storage medium of claim 15, wherein:
the value stored at the source location is a single datum; and
the external agent is to atomically access the set of memory locations by using the single datum with a defined function.
